(19) United States
(12) Patent Application Publication
(10) Pub. No.: US 2023/0318194 A1
(43) Pub. Date: Oct. 5, 2023

(54) ELECTROMAGNETIC FLUX CONTROLLING MEMBER AND MOLD

(71) Applicant: Enplas Corporation, Saitama (JP)

(72) Inventors: Takayuki ARAI, Saitama (JP); Tomohiro SAITO, Saitama (JP)

(21) Appl. No.: 17/708,433

(22) Filed: Mar. 30, 2022

(51) Int. Cl. H01Q 15/02

(52) U.S. Cl. CPC H01Q 15/02

(57) ABSTRACT

The present invention relates to an electromagnetic flux controlling member including a plurality of protrusions that can be easily molded in a shape matching a mold. An electromagnetic flux controlling member of an embodiment of the present invention is an electromagnetic flux controlling member including a plurality of protrusions. At least one of the plurality of protrusions includes a piece parting transfer line.

### TECHNICAL FIELD

The present invention relates to an electromagnetic flux controlling member, and a mold.

### BACKGROUND ART

In wireless communications, the use of lens antennas is known as a means of transmitting more information over long distances with high efficiency. Lens antennas have the ability to control the direction of travel of electromagnetic waves, including radio waves, by converting spherical waves into plane waves, etc., and recently, they have begun to be used for electromagnetic waves with shorter wavelengths such as quasi-millimeter waves, millimeter waves and terahertz waves.

In the related art, electromagnetic flux controlling members (lenses) such as the the above-described lens antennas contain a dielectric medium such as ceramics or resin. Therefore, when electromagnetic waves are incident on the lens, they have a strong tendency to be reflected due to the difference in refractive index between air and lens.

Lenses having a structure to soften the change in refractive index are known as lenses to reduce the reflection of such electromagnetic waves. Specifically, such a lens has a plurality of protrusions protruding from the lens surface. Preferably, the plurality of protrusions has a structure such that they taper as they protrude from the surface. This allows the formation of a layer on the surface of the lens in which the ratio of air to convexity (ceramic or resin) changes gradually, i.e., a layer in which the refractive index changes gradually on the surface of the lens, thereby reducing the reflection of electromagnetic waves.

### CITATION LIST

### Patent Literature

PTL 1
Japanese Patent Application Laid-Open No. 2009-198628

### SUMMARY OF INVENTION

### Technical Problem

PTL 1 discloses an antireflection structure having a plurality of protrusions as described above. Such structures are often manufactured by filling a mold with material having multiple concavities. However, because protrusions for preventing such reflections are thin, they may not match the mold when manufactured using the mold (which may result in poor transferability).

An object of the present invention is to provide an electromagnetic flux controlling member including a plurality of protrusions that can be easily molded to match the mold. In addition, another object of the present invention is to provide a mold for molding the electromagnetic flux controlling member.

### Solution to Problem

An electromagnetic flux controlling member according to an embodiment of the present invention includes a plurality of protrusions. At least one of the plurality of protrusions includes a piece parting transfer line.

A mold according to an embodiment of the present invention is configured to mold an electromagnetic flux controlling member including a plurality of protrusions. At least one of a plurality of recesses corresponding to the plurality of protrusions includes two or more pieces.

### Advantageous Effects of Invention

According to the present invention, it is possible to provide an electromagnetic flux controlling member including a plurality of protrusions that can be easily molded to match the mold. In addition, it is possible to provide a mold for molding the electromagnetic flux controlling member.

### BRIEF DESCRIPTION OF DRAWINGS

FIG. 1A is a photograph of an electromagnetic flux controlling member, FIG. 1B is a sectional view of the electromagnetic flux controlling member, and FIG. 1C is a partially enlarged bottom view of the electromagnetic flux controlling member;

FIG. 2 is a plan view of a mold for molding the electromagnetic flux controlling member;

FIG. 3 is a sectional view of a recess of the mold and a protrusion of the electromagnetic flux controlling member; and

FIG. 4 is a sectional view of the mold.

### DESCRIPTION OF EMBODIMENTS

Electromagnetic Flux Controlling Member

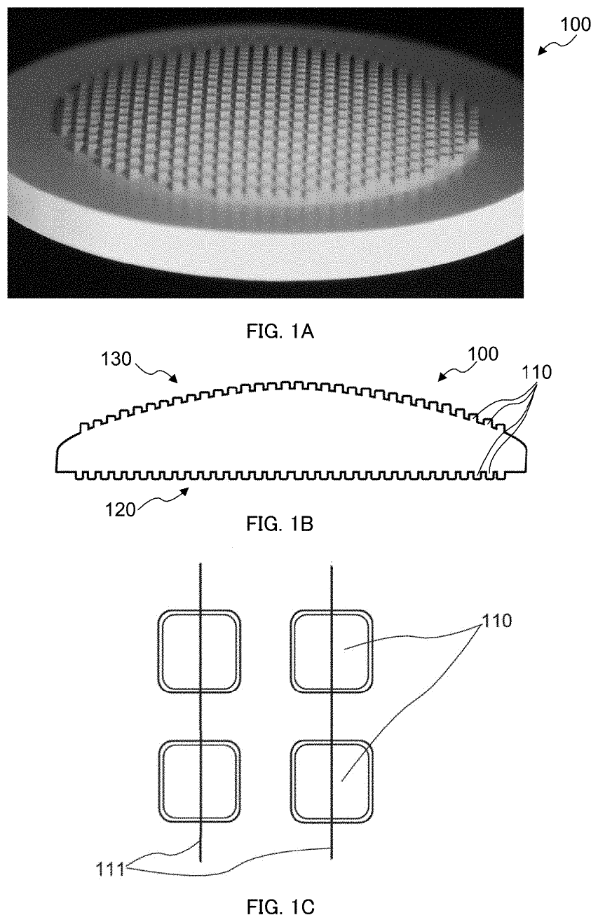

FIG. 1A is a photograph showing electromagnetic flux controlling member 100 according to an embodiment of the present invention, FIG. 1B is a sectional view of electromagnetic flux controlling member 100, and FIG. 1C is a partially enlarged bottom view of electromagnetic flux controlling member 100. Note that hatching is omitted in FIG. 1B. Note that in FIG. 1A, electromagnetic flux controlling member 100 is captured diagonally above.

As illustrated in FIGS. 1A and 1B, electromagnetic flux controlling member 100 includes a plurality of protrusions 110. In the present embodiment, electromagnetic flux controlling member 100 includes incidence surface 120 for entering electromagnetic waves, and emission surface 130 for emitting, to the outside, electromagnetic waves entered from incidence surface 120.

Preferably, the material of electromagnetic flux controlling member 100 is resin. In addition, preferably, the material of electromagnetic flux controlling member 100 contains an inorganic filler in order to increase the refractive index. Preferably, the inorganic filler is 10 vol. % or greater.

In the present embodiment, each of incidence surface 120 and emission surface 130 includes the plurality of protrusions 110. In addition, in the present embodiment, the plurality of protrusions 110 is disposed on the flat surface in incidence surface 120, and the plurality of protrusions 110 is disposed on the convex surface in emission surface 130 as illustrated in FIG. 1B. That is, in the present embodiment, electromagnetic flux controlling member 100 has a structure with protrusion 110 provided in incidence surface 120 and emission surface 130 of a planoconvex lens. Note that the shape of the lens provided with protrusion 110 is not limited to a planoconvex lens. For example, the shape of the lens provided with protrusion 110 may be a biconvex lens and the like. In addition, the shapes of incidence surface 120 and emission surface 130 may be appropriately set depending on how the electromagnetic waves should be controlled. For example, the curvatures of incidence surface 120 and emission surface 130 and the like may be appropriately set.

The portion where protrusion 110 is provided is a layer where air and the material such as the resin making up protrusion 110 are mixed. In this manner, the layer functions as a layer with a refractive index between the refractive index of the air and the refractive index of the material. Therefore, with protrusion 110, the electromagnetic waves incident on incidence surface 120 and the electromagnetic waves emitted from emission surface 130 can be prevented from being reflected due to abrupt change of the refractive index.

The shape of protrusion 110 is not limited as long as the above-mentioned function can be ensured. The shape of protrusion 110 may be a shape (such as a columnar shape) whose size does not change even when it is separated away from the surface (the incidence surface or the emission surface) of electromagnetic flux controlling member 100, or a shape whose size changes (such as a conical shape or a frustum shape). Preferably, protrusion 110 has a shape that becomes thinner as the distance from the surface of electromagnetic flux controlling member 100 increases, from a view point of softening the variation of the refractive index.

Examples of the shape of protrusion 110 include a rectangular shape, a columnar shape, a pyramidal shape, a conical shape, a truncated pyramidal shape, a truncated conical shape and the like. Among them, a pyramidal shape, a conical shape, a truncated pyramidal shape, and a truncated conical shape are preferable from a view point of softening the variation of the refractive index.

The size of protrusion 110 may be appropriately selected in accordance with the wavelength of the electromagnetic waves for which reflection is to be prevented. For example, in the case of a frequency of 300 GHz band, it suffices that in plan view, the maximum length of protrusion 110 is approximately 200 to 500 μm and the height of protrusion 110 is approximately 200 to 500 μm. In addition, in the case of a frequency of 100 GHz band, for example, it suffices that in plan view, the maximum length of protrusion 110 is approximately 600 to 1500 μm, and the height of protrusion 110 is approximately 600 to 1500 μm. In addition, preferably, the size of protrusion 110 is half the wavelength of the electromagnetic waves or smaller, and is the processing limit or greater.

In addition, preferably, protrusion 110 has a shape that does not have sides where the angle between two surfaces is 90° or smaller from a view point of increasing the mold releasability. From this view point, the protrusion preferably has a chamfered rectangular prism shape, a chamfered pyramidal trapezoidal shape, a chamfered pyramidal shape or the like. Preferably, the top surface and/or the bottom of protrusion 110 is chamfered. Examples of the chamfer include C-chamfer and R-chamfer.

Note that in the present embodiment, protrusion 110 is a quadrangular prism with chamfered eight sides as illustrated in FIGS. 1A to 1C.

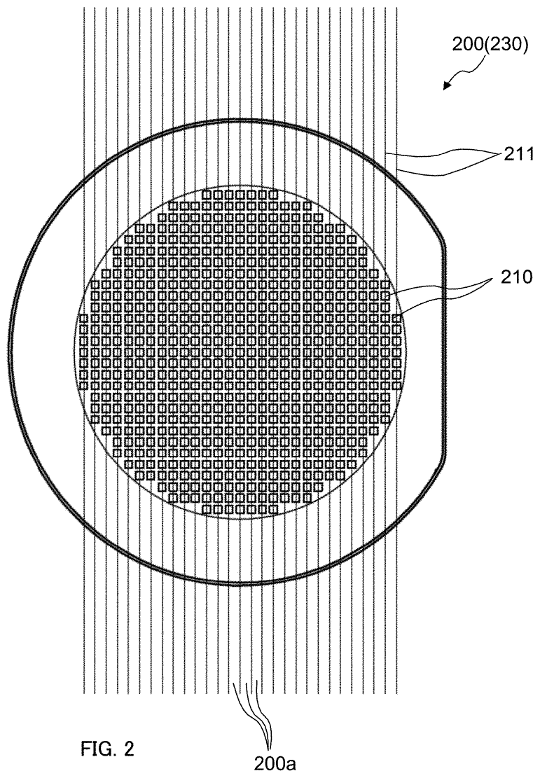

As illustrated in FIG. 1C, protrusion 110 includes piece parting transfer line 111. Piece parting transfer line 111 is a line generated by transferring piece parting boundary line 211 provided at recess 210 of mold 200 with a shape complementary to protrusion 110 (see FIG. 2). Piece parting boundary line 211 is a boundary of a plurality of pieces 200a making up mold 200. During the molding, piece parting boundary line 211 of mold 200 serves as an entrance of a loophole through which the molding material cannot pass while the gas generated from the molding material and the air in recess 210 and the like can pass. Note that the air and/or the gas entered from the entrance is ejected to the outside through a part between a plurality of pieces (the loophole).

Recess 210 corresponding to protrusion 110 provided with piece parting boundary line 211, i.e., protrusion 110 provided with piece parting transfer line 111, means that electromagnetic flux controlling member 100 has been molded without affected by the air or gas. That is, this means that protrusion 110 has been molded to match the shape of mold 200.

It suffices that piece parting transfer line 111 is disposed in any of the location in protrusion 110. More specifically, preferably, in plan view of protrusion 110, at least a part of piece parting transfer line 111 is disposed inside the outer edge of protrusion 110. In addition, preferably, at least a part of piece parting transfer line 111 is disposed at the top surface or the end of protrusion 110 from a view point of suppressing the influence of the air and the gas. In addition, in the case where piece parting transfer line 111 is disposed at the top surface of protrusion 110, it is preferable that piece parting transfer line 111 be disposed to pass through the topmost part of the top surface.

In FIGS. 1A to 1C, all (100%) of the plurality of protrusions 110 provided in electromagnetic flux controlling member 100 (incidence surface 120 and emission surface 130) include piece parting transfer line 111, but electromagnetic flux controlling member 100 of the present embodiment is not limited to this. 80% or more of the plurality of protrusions 110 provided in electromagnetic flux controlling member 100 may include piece parting transfer line 111, or 50% or more of the plurality of protrusions 110 may include piece parting transfer line 111. Alternatively, at least one of the plurality of protrusions 110 may include piece parting transfer line 111. Even when all of the plurality of protrusions 110 do not include piece parting transfer line 111, a plurality of protrusions can be molded to match the mold in such a manner as to achieve the effect of preventing the reflection by reducing the influence of the air and the gas. Note that from a view point of molding protrusion 110 to match mold 200, the larger the ratio of protrusions 110 including piece parting transfer line 111, the more preferable.

It suffices to appropriately adjust the thickness (width) of piece parting transfer line 111 such that during the molding, the molding material does not escape from piece parting boundary line 211 while the air, the gas and the like escape. More specifically, the thickness of piece parting transfer line 111 may span from a visually recognizable thickness to a thickness that can be observed using devices such as optical microscopes and electron microscopes.

In the present embodiment, piece parting transfer line 111 extends from the end to end of electromagnetic flux controlling member 100 in plan view of electromagnetic flux controlling member 100. In addition, in the present embodiment, in plan view, a plurality of piece parting transfer lines 111 parallel to each other is provided.

In electromagnetic flux controlling member 100, it is preferable that one piece parting transfer line 111 is shared by a large number of protrusions 110. Specifically, it is preferable that the plurality of protrusions 110 be disposed such that they are at least partially located on one piece parting transfer line 111 in plan view of electromagnetic flux controlling member 100. In the present embodiment, in plan view, the plurality of protrusions 110 is disposed in a grid, and a plurality of piece parting transfer lines 111 parallel to each other is disposed to pass through the plurality of protrusions 110.

Mold

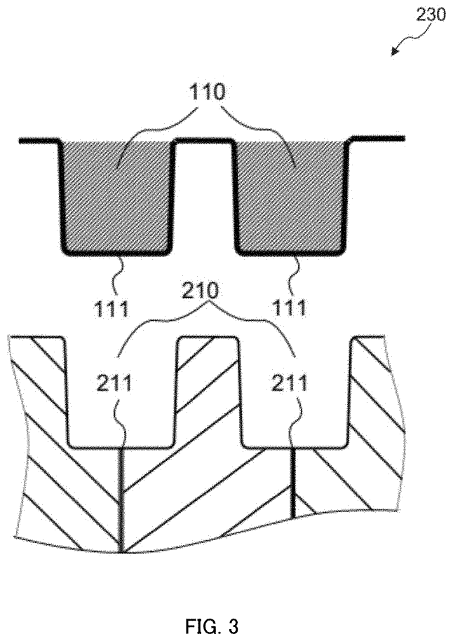

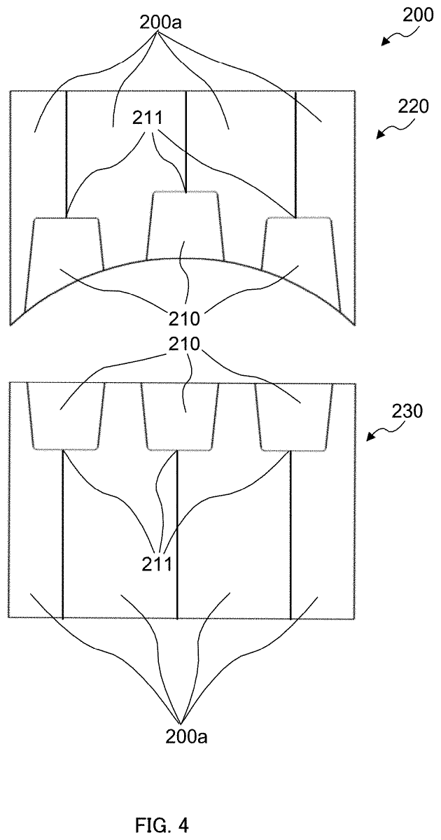

FIG. 2 is a plan view of second mold 230, which is a mold on incidence surface 120 side. FIG. 3 is a sectional view of recess 210 of second mold 230. Note that FIG. 3 also illustrates a cross section of protrusion 110, which is formed by recess 210 of second mold 230. FIG. 4 is a schematic cross-sectional view illustrating first mold 220 (upper side), which is a mold on the emission surface side, and second mold 230 (lower side), which is a mold on the incidence surface side. In FIG. 4, the size of recess 210 and the like are increased, and hatching is omitted. Mold 200 is configured for molding the above-mentioned electromagnetic flux controlling member 100, and has a shape complementary to electromagnetic flux controlling member 100.

The material of mold 200 is not limited as long as it has a rigidity with which the molding material can be supplied and electromagnetic flux controlling member 100 can be molded, and may be appropriately selected from publicly known materials. Examples of the material of mold 200 include metal.

In the present embodiment, first mold 220 includes a curved concave surface of a shape corresponding to emission surface 130. A plurality of recesses 210 is disposed in this curved concave surface.

In the present embodiment, second mold 230 includes a flat surface of a shape corresponding to incidence surface 120. The plurality of recesses 210 is disposed at this flat surface.

The plurality of recesses 210 have shapes complementary to the plurality of protrusions 110. Examples of the shape of recess 210 include a rectangular prism shape, a columnar shape, a pyramidal shape, a conical shape, a truncated pyramidal shape, a truncated conical shape and the like. In addition, the plurality of pieces 200a is formed with recess 210.

The size of recess 210 may be appropriately selected in accordance with the wavelength of the electromagnetic waves for which reflection is to be prevented. In the case of a frequency of 300 GHz band, it suffices that in plan view, the maximum length of recess 210 is approximately 200 to 500 μm, and the depth of recess 210 is approximately 200 to 500 μm. In addition, in the case of a frequency of 100 GHz band, it suffices that in plan view, the maximum length of recess 210 is approximately 600 to 1500 μm, and the height of recess 210 is approximately 600 to 1500 μm, for example. In addition, preferably, the size of recess 210 is half the wavelength of the electromagnetic waves or smaller, and is the processing limit or greater.

In addition, preferably, recess 210 has a shape that does not have sides where the angle between two surfaces is 90° or smaller from a view point of increasing the mold releasability. From this view point, preferably, recess 210 has a chamfered rectangular prism shape, a chamfered pyramidal trapezoidal shape, a chamfered pyramidal shape or the like. The examples of the chamfer include C-chamfer and R-chamfer.

Note that in the present embodiment, recess 210 is a quadrangular prism with chamfered eight sides in plan view.

Recess 210 is composed of two or more pieces 200a. The boundary line of two pieces 200a is piece parting boundary line 211. In the present embodiment, one recess 210 is composed of two pieces 200a, and accordingly recess 210 includes one piece parting boundary line 211.

As described above, piece parting boundary line 211 serves as an entrance of a loophole from which the gas generated from the molding material and the air in recess 210 can escape during the molding. Accordingly, the molding material is appropriately supplied into recess 210, and protrusion 110 is molded into a shape matching mold 200.

It suffices that piece parting boundary line 211 is disposed in any of the location in recess 210. More specifically, preferably, at least a part of piece parting boundary line 211 is disposed inside the outer edge of recess 210 in plan view of recess 210. In addition, preferably, at least a part of piece parting boundary line 211 is disposed at the most depth side end or the bottom surface of recess 210 from a view point of the suppressing the influence of the air and the gas. In addition, in the case where piece parting boundary line 211 is disposed at the bottom surface of recess 210, it is preferable that piece parting boundary line 211 be disposed to pass through the most depth side part of the bottom surface.

In FIG. 4, all (100%) of recesses 210 provided in mold 200 (first mold 220 and second mold 230) include piece parting boundary line 211, but mold 200 of the present embodiment is not limited to this. 80% or more of recesses 210 provided in mold 200 may include piece parting boundary line 211, or 50% or more of recesses 210 may include piece parting boundary line 211. In addition, at least one of the plurality of recesses may include piece parting boundary line 211. Even when all recesses 210 do not include piece parting boundary line 211, protrusion 110 can be molded in a shape matching the mold in such a manner as to achieve the effect of preventing the reflection by reducing the above-described influence of the air and the gas. Note that from a view point of molding protrusion 110 to match the mold 200, the larger the ratio of recesses 210 including piece parting boundary line 211, the more preferable.

It suffices that the thickness (width) of piece parting boundary line 211 is a size through which the molding material cannot pass while the air and the gas and the like can pass during the molding. More specifically, the thickness of piece parting boundary line 211 may span from a visually recognizable thickness to a thickness that can be observed using devices such as optical microscopes and electron microscopes.

In the present embodiment, piece parting boundary line 211 extends from the end to end of mold 200 in plan view of mold 200. In addition, in the present embodiment, a plurality of piece parting boundary lines 211 are parallel to each other.

In mold 200, it is preferable that a large number of recesses 210 share one piece parting boundary line 211. That is, in plan view of mold 200, the plurality of recesses 210 is disposed such that they are at least partially located on one piece parting boundary line 211. In the present embodiment, in plan view, the plurality of recesses 210 is disposed in a grid, and a plurality of piece parting boundary lines 211 parallel to each other is disposed to pass through the plurality of recesses 210.

Molding Procedure

An example of a procedure of molding electromagnetic flux controlling member 100 is described below.

First, mold 200 is prepared. More specifically, first mold 220 and second mold 230 are fixed at predetermined positions. Next, the molding material is emitted to the cavity between first mold 220 and second mold 230. At this time, the gas generated from the molding material and the air in recess 210 are ejected from piece parting boundary line 211. In this manner, protrusion 110 of electromagnetic flux controlling member 100 is easily molded to match mold 200.

Next, the molding material is solidified by cooling it under pressure. Next, first mold 220 and second mold 230 are opened, and the molded electromagnetic flux controlling member 100 is removed. In this manner, electromagnetic flux controlling member 100 can be obtained.

Effects

The electromagnetic flux controlling member according to the present embodiment can easily mold a protrusion that can suppress the reflection of electromagnetic waves in a shape matching the mold. In addition, the mold according to the present embodiment can mold the above-mentioned electromagnetic flux controlling member.

### INDUSTRIAL APPLICABILITY

The electromagnetic flux controlling member and the mold according to the present invention is suitable for performing communication using electromagnetic waves and the like while reducing the influence of the reflection.

### REFERENCE SIGNS LIST

100 Electromagnetic flux controlling member
110 Protrusion
111 Piece parting transfer line
120 Incidence surface
130 Emission surface
200 Mold
200a Piece
210 Recess
211 Piece parting boundary line
220 First mold
230 Second mold

1. An electromagnetic flux controlling member, comprising a plurality of protrusions, wherein at least one of the plurality of protrusions includes a piece parting transfer line.

2. The electromagnetic flux controlling member according to claim 1, wherein each of 50% or more of the plurality of protrusions includes a piece parting transfer line.

3. The electromagnetic flux controlling member according to claim 1, wherein in plan view, at least a part of the piece parting transfer line is disposed inside an outer edge of each of the plurality of protrusions.

4. The electromagnetic flux controlling member according to claim 1, wherein at least a part of the piece parting transfer line is disposed at a top surface of each of the plurality of protrusions.

5. The electromagnetic flux controlling member according to claim 1, wherein each of the plurality of protrusions has a chamfered rectangular prism shape or a chamfered pyramidal trapezoidal shape.

6. The electromagnetic flux controlling member according to claim 1, wherein the electromagnetic flux controlling member contains 10 vol. % or more inorganic filler.

7. A mold configured to mold an electromagnetic flux controlling member including a plurality of protrusions, wherein at least one of a plurality of recesses corresponding to the plurality of protrusions includes two or more pieces.

8. The mold according to claim 7, wherein each of 50% or more of the plurality of recesses includes two or more pieces.

9. The mold according to claim 7, wherein in plan view, a piece parting boundary line is provided inside an outer edge of the recess.

10. The mold according to claim 7, the recess has a chamfered rectangular prism shape or a chamfered pyramidal shape.
